(19) United States
(12) Patent Application Publication
(10) Pub. No.: US 2006/0276950 A1
(43) Pub. Date: Dec. 7, 2006

(54) Motor vehicle

(75) Inventors: Horst Wild, Engelthal (DE); Klaus Wohlrab, Weissenburg (DE); Harald Engelhardt, Ingolstadt (DE)

Correspondence Address: CONTINENTAL TEVES, INC., ONE CONTINENTAL DRIVE, AUBURN HILLLS, MI, 48326-1581, US

(73) Assignee: CONTI TEMIC microelectronic GmbH, Nurnberg (DE)

(21) Appl. No.: 10/549,058

(22) PCT Filed: Mar. 12, 2004
(86) PCT No.: PCT/EP04/02571

§ 371 Date: Jun. 30, 2006

(30) Foreign Application Priority Data
Mar. 14, 2003 (DE) 103 11 638.9

(51) Int. Cl. G06F 17/00

(52) U.S. Cl. 701/51

(57) ABSTRACT

Disclosed is a motor vehicle with an automatic gearbox, a gearbox control unit comprising several driving programs which control the gear switching operation and a selection lever for manual selection between a normal D driving program with automatic gearbox adjustment and a sporty S driving program. The motor vehicle also includes automatic gearbox adjustment and/or a manual driving program with manual gearbox adjustment. The gearbox control unit (3) is designed to automatically change from the S driving program or the manual driving program to the D driving program, depending on at least one operating parameter of the vehicle (1).

### BACKGROUND OF THE INVENTION

The invention relates to a motor vehicle with an automatic gearbox, a gearbox control unit comprising several driving programs which control the gear switching operation and a selection lever for manual selection between a normal D driving program with automatic gearbox adjustment and a sporty S driving program with automatic gearbox adjustment and/or a manual driving program with manual gearbox adjustment.

Motor vehicles which have a gearbox with automatic gearbox adjustment—whether it be a continuous automatic gearbox where the gearbox is changed continuously between different gears, or a multiply defined automatic switching gearbox, which comprises six gears, for example—offer the option on the one hand of selecting a normal, standard D driving program via the manually activated selection lever. With this D driving program, the gearbox is automatically adjusted using an automatic gear change with automatic switching units, or using corresponding automatic gearbox adjustment with continuous automatic units, the switching or adjustment strategy being conservative, i.e. the change is usually made at an early stage when rotational speeds are low. On the other hand, they offer the option of selecting a sporty program—frequently known as the sporty S driving program—via a selection lever, whereby here, an automatic gearbox adjustment is made which is also dependent on the type of automatic gearbox, although the switch or adjustment is only made at higher rotational speeds, or higher output moments compared to the D driving program, generally making more sporty driving possible. In addition to, or as an alternative to the selectable S driving program, the option is available to change to manual switching or adjustment operation. Options such as these are offered in the form of a “tiptronic” function, for example. Here, the selection lever must be positioned in the so-called “tiptronic” channel. Then the driver can manually switch the individual gears him or herself, i.e. no automatic gearbox adjustment is made. This as it were enables the standard manual switching operation known from manual gearboxes. An automatic adjustment is only made when a maximum rotational speed is reached in the manually set condition, for example.

Normally, the program selected by the driver remains set and is implemented until it is altered by the driver using the selection lever. However, the manually selectable S and manual driving programs generally consume more fuel than the standard D automatic driving program. This applies above all to starting up, since in “tiptronic” mode, for example, the vehicle is driven in first gear until the driver switches up a gear themselves, or until the maximum rotational speed is reached, while in the D driving program, the change is made to the next switching stage or gear relatively quickly. If the driver has set a special program of this type, they are frequently surprised themselves by the high rotational speeds during start-up, although they have only relatively slightly opened the throttle, which occurs in particular when they have forgotten, due to the fact that they have been standing still or driving at constant speed for some time, that they are not in the normal D driving program, but in the S driving program, or “tiptronic” mode. The higher rotational speeds necessarily lead to higher fuel consumption and are also a nuisance, forcing the driver to look for their cause, with the result that they may be temporarily unable to concentrate on the traffic.

### SUMMARY OF THE INVENTION

The object of the invention is therefore to provide a motor vehicle which can assist in this matter.

In order to solve this problem, a motor vehicle of the type described in the introduction is proposed, for which the design of the gearbox control unit for automatically changing from the S driving program, or manual driving program, into the D driving program, is dependant on at least one operating parameter of the vehicle.

The motor vehicle according to the invention automatically changes particularly advantageously from the set special driving program to the normal, conservative D driving program when the situation requires it to do so. The change made is dependant on at least one operating parameter of the vehicle, i.e. it is dependant on the actual operating parameter, in other words, the actual situation in which the vehicle finds itself. According to the invention, the speed, the output speed of the gears and/or a time interval can be the operating parameters. For example, a change can be made when a prespecified speed threshold value is not reached by the actual speed; alternatively or in addition, the option is available of making the change when the output speed of the gears fails to reach a gear output speed threshold value. It would also be possible to make a change when a specific time interval has passed, preferably one which is triggered when the special driving program is selected. If the change made is dependant on the speed, it is assumed when the relatively low speed threshold level is not met that the special driving program is no longer required, at least in relation to the actual operating situation, for which reason it appears to be appropriate, e.g. in order to reduce fuel consumption and to avoid a subsequent start-up with a higher rotational speed, to change to the normal D driving program. The same principle applies in relation to the output speed of the gears. A time interval can also be used as an operating parameter, said time interval being triggered when the special driving program is selected. This creates, as it were, a time window, within which the special program remains active, it being possible, as described in greater detail below, to trigger said time window again as necessary, dependant on the driving mode, in order to avoid changing the program unnecessarily.

These operating parameters can each be used individually as the basis for a change. It is also possible to use the speed in connection with a time interval as a dependence criterion for a change, for example. In this case, a time interval is triggered, for example, when the actual speed fails to reach the speed threshold value. If this condition remains after the time interval has lapsed, the change can be made. However, if the speed alters, with the result that the actual speed is higher than the speed threshold value before the time interval has lapsed, it is not necessary to change the program.

The speed threshold value can for example be ≦20 km/h, particularly ≦10 km/h, the output speed of the gears can for example be ≦200 rpm, particularly ≦150 rpm, the time interval can be ≦10 s and particularly ≦10 mins. Particularly the threshold value for the output speed of the gears, and therefore also the output speed of the gears, depends on the gear ratio or the configuration of the gears themselves, so that it is also entirely possible to use higher rotational speed threshold values.

If a time interval is intended as a dependence criterion, it is necessary to design the gearbox control unit for any appropriate re-triggering of the time interval. This therefore continuously checks, as it were, whether or not the S driving program or the manual driving program is still required. The time interval can be re-triggered, for example, when a drive around a bend is detected, when a traverse acceleration threshold value is exceeded, when a measured minimum bend radius is not reached, when an acceleration threshold value is exceeded or not reached, or when an accelerator pedal angle is exceeded or not reached. If, for example, a drive around a bend is detected, it may be clear that the sporty driving program is still required, for example, in order to be able to drive with the corresponding output margins. A drive around a bend of this nature can be measured, for example, by measuring the steering angle; it is also possible to use a camera which has been fitted for another system, for example (e.g. an LDW—Lane Departure Warning—system, or similar) for this purpose. For example, a traverse acceleration can be determined from the measured rotational speeds of the wheels, i.e. when there is a difference between the rotational speeds of the left wheels and the right wheels, it also being possible, incidentally, to measure a potential drive around a bend in this way. The same principle applies in relation to a minimum bend radius. Re-triggering can also occur when a longitudinal acceleration threshold value is exceeded or not reached, i.e. a change is not necessary when, for example, the acceleration threshold value is exceeded due to unequivocal acceleration, or when there is negative acceleration due to a strong braking action, with the result that the acceleration threshold value is clearly not reached. The same principle applies to the accelerator pedal angle. If the accelerator is fully pressed down, this is an indication that the driver wishes to accelerate to an extreme degree. The same principle applies when the accelerator is released very quickly, e.g. in order to use the brake. This can also be used as an indication that no change is required, and that it is far more appropriate to re-trigger the time interval.

According to a particularly advantageous embodiment of the invention, it can also be provided that the design of the gearbox control unit is dependent on at least one, and if appropriate, more than one operating parameter, in order to change again into the previously selected S or manual driving program. For the driver, this embodiment of the invention has a particular advantage in that in general, a change is made to the fuel-saving D driving program when necessary, but that a second change is made back into the previously selected driving program immediately the situation requires it; in other words, when a measured operating parameter indicates that the driving and performance characteristics selected according to the wishes of the driver with the S or manual driving program are again required. Continuous monitoring therefore takes place as to whether the set special program is no longer required, or whether it is again required. This makes it possible to change the program in an optimum manner which helps save fuel on the one hand, while on the other, always making the desired characteristics available whenever necessary.

A second change of this type can be made when a second speed threshold value is exceeded, for example. This second speed threshold value, which is advantageously set higher than the first speed threshold value, and on which the first change into the D driving program is dependent, is exceeded when the vehicle accelerates. This can be used in urban traffic situations, for example, where very slow stop-and-go operation is very common, particularly at traffic lights, in order to prevent constant changing between the D driving program and the other previously set program; it is far more the case that the D driving program is set continuously for as long as the second speed threshold value is not exceeded, which is often the case in such situations.

As an alternative to making the change dependent on the speed, the change can also be made when a second acceleration value, if appropriate, is exceeded or not reached, or when a second accelerator pedal angle threshold value, if appropriate, is exceeded or not reached and/or when a traverse acceleration threshold value, if appropriate, is exceeded or not reached. These operating parameter threshold values, or the operating parameters assigned to them, form the basis, as described above, of a possible initial program change, for which reason they can equally form the basis for the reverse change. After all, in cases when the driver again accelerates when a change has just been made to the D mode, it is probable that the higher acceleration characteristics which have for example been assigned to the S driving program are required, for which reason a reverse change is required immediately. Alongside these real operating parameters, however, it is also conceivable that for example a signal from a button or similar which is manually activated by the driver be used as a further operating parameter which determines whether a change is made. This embodiment of the invention may be equally useful but it does require the active participation of the driver.

In a further development of the basic concept of the invention, it can be provided that the second change is made when a speed threshold value is exceeded, and when at least one of the operating parameter threshold values—the acceleration threshold value, the accelerator pedal angle threshold value or the traverse acceleration threshold value—is exceeded or not reached. In other words, the second change is dependent on two operating parameters, which must exceed or fail to reach their assigned threshold values. If the actual speed exceeds the speed threshold value, but is combined with a very modest acceleration, it is not absolutely necessary for consumption reasons to change back into the special program. It is far more the case that the performance parameters required at that moment are also made available via the D driving program. After the parameters have been continuously measured, and the comparison has been continuously made with the assigned threshold values, however, the moment in which the performance characteristics are required which have been assigned to the special program can be detected in each case, and an immediate reaction can be made.

The relevant operating parameter threshold value can either be prespecified as a fixed value, i.e. the threshold values are dependent on the vehicle type, for example, or the performance characteristics of a drive aggregate etc. are prespecified as fixed values at one point while the vehicle is being constructed, or can be changed in the factory or as part of the customer service agreement, for example; in any case, they are always implemented as fixed values. As an alternative, the option is available of making the relevant operating parameter threshold value variable, depending on the actual speed, the motor vehicle load, the inclination of the road or a driving strategy which forms the basis of the control operation. In other words, here, the threshold value is adapted to the momentary operation of the vehicle, or taking external influences into account. For example, if a trailer is coupled to the vehicle, the acceleration behaviour is naturally different, and the operating characteristics required by the driver are also different than when the vehicle is driven without a trailer. If the relevant threshold value is variable, it can be adapted to the real-life conditions. The same principle applies to the road inclination. Different threshold values are required when driving uphill than when driving downhill. The relevant parameters or parameter threshold values are measured using appropriate sensors in the manner described above, said sensors usually being already available on the vehicle ex works, or if necessary, appropriate camera facilities etc. are used, particularly when external characteristics apply such as driving around bends, driving uphill etc.

While the second threshold values for the acceleration, traverse acceleration or accelerator pedal angle can be the same as those which form the basis of the initial change from the special program into the D driving program, with regard to the second speed threshold value, it is advantageous, as described above, that it be set higher than the first speed threshold value. The difference can be configured according to the program change operation concept, e.g. it can be 2.5 km/h, 10 km/h or more.

Finally, it can be provided in a further development of the basic concept of the invention that despite a successful change into the D driving program, the driving program originally selected is displayed on a display device for the driving program. For example, if an automatic change is made from the S driving program to the D driving program, the driver continues to be shown the originally selected S driving program. There is therefore no continuous change in the display, which can be confusing, particularly when the system changes back and forth within a short period of time. Incidentally, the display for the D driving program is also not required by the driver, since the immediate change back into the originally selected driving program in accordance with the invention means that this program is directly available to them.

The driver has the option of either changing from one program to the other as they wish while driving, i.e. of switching over from the D driving program to the S driving program, for example. If a situation then arises which justifies or demands a program change to the D driving program, the program change described above is made, for example when the driver is approaching a traffic light and reduces their speed accordingly, or when they are at a standstill. However, the option is also available of selecting the S driving program or the manual driving program when already at a standstill, or when the actual speed or the actual rotational speed is lower than the assigned set value, e.g. when the driver has just started the engine or is standing at a traffic light and decides to follow this procedure. In this case, two options are conceivable. On the one hand, the selected special program can be implemented, since the driver has just consciously selected this program. In other words, the engine would also be started up, for example, taking the control parameters of the S driving program as a basis. Alternatively, the option is available of using the program change function according to the invention during this start-up which follows the selection when at a standstill, and to use the D driving program for the start-up procedure. Therefore, a conservative start-up follows, as it were, even if the driver has selected the sporty program variant, for example. The actual change can be displayed to the driver in this special case, e.g. via an appropriate display device. In order to definitively select the special program, the driver must then activate the selection lever again, for example, or they must briefly confirm their original selection, or similar. However, particularly when the gearbox control unit is designed for a reverse change, the option is available, despite switching over to the D driving program during the start-up procedure, of immediately changing to the selected S or manual driving program, e.g. when the driver accelerates sufficiently rapidly, or similar. In this case, the full performance capacity of the selected special program is available to the driver, even when the intelligent gearbox control unit has switched back to the fuel-saving D driving program for reasons of economy.

Further advantages, characteristics and details of the invention are outlined in the exemplary embodiment described below, and on the basis of the drawing.

### BRIEF DESCRIPTION OF THE DRAWING

The figure shows a motor vehicle including an automatic gearbox.

### DETAILED DESCRIPTION OF THE DRAWING

The drawing shows a motor vehicle in accordance with the invention 1, comprising an automatic gear unit 2 to which a gearbox control unit 3 and a selection lever 4 are assigned. The selection lever can be used to select a driving program stored in the gearbox control unit 3, which is then retrieved and executed in the gearbox control unit 3. In the example shown, only three sample driving programs can be selected via the selection lever: a “normal”, in terms of the driving strategy conservative, fuel-saving D driving program, alongside which is a sporty, S driving program, with which the gears are also adjusted automatically, and a manual driving program, referred to in the example shown as the T driving program (T=“Tiptronic”), with which the driver manually adjusts the gears to switch down or up by briefly pressing the selection lever 4 accordingly, or a relevant switch on the selection lever or on the steering wheel. Depending on which selection lever position is set, and which driving program is selected, the corresponding driving program is executed in the control unit 3.

In the example shown, the S driving program has been set, and is retrieved and executed. The control unit 3 is designed in such a way as to automatically change from the S driving program to the D driving program when this is required by the current situation, or when it appears to be appropriate. For this purpose, a suitable device 5 for measuring the speed, e.g. the standard speed sensor, is used to measure the actual speed v, which is transmitted to the control unit 3. In addition to this, or as an alternative, a suitable device 6 for measuring the output speed of the gears U also measures this speed, which is transmitted to the control unit 3. Here, the current actual speed value v or the actual rotational speed value U is compared with a corresponding threshold value, in the case of the speed, with a speed threshold value v₁, or in the case of the rotational speed, with a rotational speed threshold value U₁. If the actual speed v is lower than the speed threshold value v₁, an automatic change is made in the control unit 3 from the S driving program to the D driving program. 10 km/h is set as a set speed value v₁, for example, which is either implemented as a fixed value, or in the case of a variable threshold value selection, at a comparative point in time. As soon as v is lower than v₁, as already described, the program is changed. The same principle applies when the rotational speed is compared; a rotational speed threshold value U₁ can be 200 rpm, for example, whereby this value can be either fixed or variable. In the case of a variable threshold value selection, the selected threshold value can depend for example on the actual speed, the motor vehicle load (e.g. trailer operation), the inclination of the road or a general driving strategy which forms the basis of the control operation (sporty, comfortable, conservative etc.).

In the embodiment of the invention shown, a timer 7 is additionally fitted in the control unit 3. This timer 7 is triggered at that moment, for example, when the driver sets the selection lever 4 to the S driving program. If the time interval then elapses, a program change can also be made when for example neither the speed nor the rotational speed are executed as change parameters. However, it is particularly advantageous if the time interval is processed in connection with the speed in particular. If for example the speed is constant within the time interval (and where appropriate, the rotational speed is additionally relatively low), this can be evaluated as an indication that the S program is no longer required due to the constant driving, and a change can be made to the D program. It is therefore possible, in cases when the time interval, represented in the Fig. by Δt, is taken into account, to make the change in connection with at least one additional operating parameter.

As well as changing from the set special driving program to the D driving program, the control unit 3 is also designed for changing back into the originally set special program. This reverse change can be made when there are different operating parameters or situations. For example, it is therefore possible to change back to the S driving program when the actual speed v increases and exceeds a second speed threshold value v₂, which is higher than the first speed threshold value v₁. A reverse change can already be made in this case. Additionally, it is also possible to only make this change when v is higher than v2 on the one hand, and on the other hand, when there is sufficient acceleration. For this purpose, the control unit 3 is designed to determine a longitudinal acceleration a, for example. If the driver of the vehicle therefore accelerates sufficiently rapidly, and v is higher than v₂, this is an indication that the characteristics assigned to the S driving program are required, for which reason an immediate reverse change is made. However, if acceleration is low, i.e. if the vehicle only accelerates slowly, the driving characteristics assigned to the D driving program may be sufficient, and no change is required.

A reverse change can also be made, however, dependent on the position or movement of the accelerator pedal 8, i.e. the accelerator pedal. If this pedal is pressed relatively quickly or far down after the first change to the D driving program, for example, in other words, when an accelerator pedal angle threshold value is exceeded while the pedal is being pressed, this is an indication that sufficient acceleration is required, for which reason the reverse change to the S driving program can already be made when this parameter is present. As an alternative, this can be made in connection with the actual speed v, as already described in relation to the processing of the longitudinal acceleration a, when the actual speed is higher than the second speed threshold value v₂.

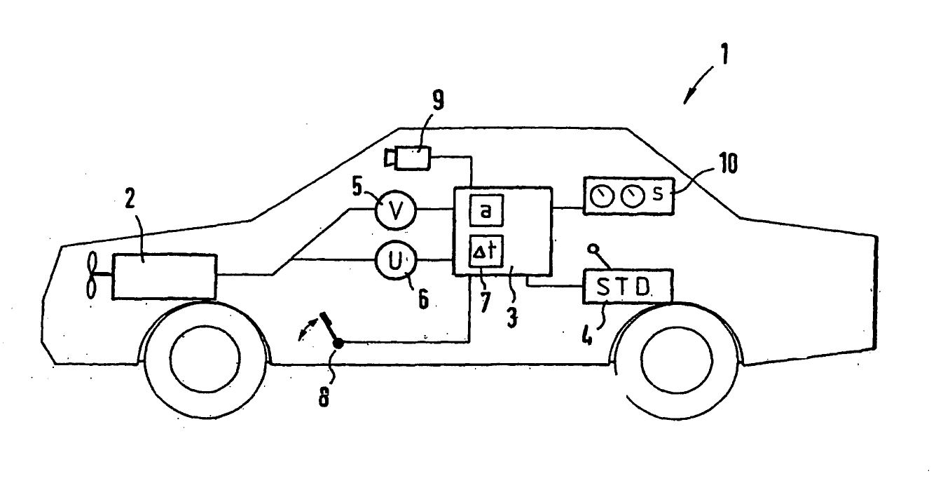

A reverse change to the S driving program can also be made, however, when a drive around a bend is detected, for example, or when a sufficient traverse acceleration threshold is exceeded while driving around a bend, or a bend radius is exceeded. These parameters can be measured on the basis of a measurement of the steering angle, for example, which is not shown in detail in FIG. 1. In this case, the steering angle or the set wheel angle, which is an indication that the vehicle is driving around a bend, is measured by sensors. These sensors can also be used to measure the bend radius. The option is also available to calculate the traverse acceleration, based on the deflection of the steering angle in connection with the actual speed, and to compare this with a traverse acceleration threshold value. Depending on how closely the bend is taken, this can be an indication that the driver is driving in a sporty manner, and that it is advantageous to switch back to the S driving program.

The option is also available of recording road-specific information using a camera 9, such as those available on vehicles with implemented track recording systems or similar, for example. This can easily be used to detect whether the road describes a bend, and if so, what the bend radius is; this information can be taken from the pictures recorded.

Finally, a further display device 10 is shown, such as the dashboard, on which the set driving program is shown alongside the standard information such as the speed and rotational speed. In the example shown, “S” is given for the S driving program selected via the selection lever 4. This originally selected program is shown continuously, even when a change is made to the D driving program. On the one hand, this change can only be for a relatively short duration when the operating parameter(s) measured make it necessary to make a rapid reverse change. Furthermore, the full performance capacity of the S driving program is available to the driver at that moment when it is required, due to the advantageous immediate reverse change back to the S driving program. As a result, it is not of importance to the driver, or is not of relevance, whether the S driving program is shown, even when the D driving program is actually set, in particular in order to reduce fuel consumption. This also avoids a frequent change on the display, which can become confusing.

In summary, the motor vehicle according to the invention offers the option of changing to the fuel-saving D driving program when the external conditions or operating circumstances make it appear advantageous. In addition, the option of making an immediate reverse change makes it possible to make use of the specific performance and operating characteristics of the special program at any point in time. For the driver, this means having the option of saving fuel when appropriate, while on the other hand, being able to make use of the full performance capacity of the desired special program at any point in time.

1-12. (canceled)

13. A motor vehicle comprising:
an automatic gearbox;
a gearbox control unit having two or more driving programs which control a switching operation of the automatic gearbox; and
a selection lever for enabling manual selection between a normal driving program with automatic gearbox adjustment and at least one additional driving program with automatic gearbox adjustment or manual gearbox adjustment, wherein the gearbox control unit automatically changes from the additional driving program to the normal driving program depending upon at least one operating parameter of the motor vehicle.

14. The motor vehicle according to claim 13, wherein the at least one additional driving program is a sporty driving program with automatic gearbox adjustment.

15. The motor vehicle according to claim 13, wherein the at least one additional driving program is a manual driving program with manual gearbox adjustment.

16. The motor vehicle according to claim 13, wherein the at least one additional driving program comprises both a sporty driving program with automatic gearbox adjustment and a manual driving program with manual gearbox adjustment.

17. The motor vehicle according to claim 13, wherein the at least one operating parameter includes at least one of a speed of the motor vehicle, an output speed of gears in the gearbox, and a time interval.

18. The motor vehicle according to claim 17, wherein the automatic change from the additional driving program to the normal driving program is made when at least one of a speed threshold value is not reached, a threshold value for the speed of the gears is not reached, or a time interval has lapsed.

19. The motor vehicle according to claim 18, wherein the speed threshold value is less than or equal to 20 km/h, the threshold value for the output speed of the gears is less than or equal to 200 rpm, and the time interval is at least 10 s and is no more than 10 mins.

20. The motor vehicle according to claim 18, wherein the speed threshold value is less than or equal to 10 km/h, the threshold value for the output speed of the gears is less than or equal to 150 rpm, and the time interval is at least 10 s and is no more than 10 mins.

21. The motor vehicle according to claim 18, wherein the gearbox control unit re-triggers the time interval.

22. The motor vehicle according to claim 21, wherein the time interval is re-triggered when at least on of the following conditions is detected: the motor vehicle is driving around a curve, a lateral acceleration threshold value is exceeded, when an acceleration value is exceeded, an acceleration value is not reached, an acceleration pedal angle threshold value is exceeded and an acceleration pedal angle threshold value is not reached.

23. The motor vehicle according to claim 13, wherein the gearbox control unit is designed for changing back to the previously selected additional driving program depending on at least one additional operating parameter.

24. The motor vehicle according to claim 23, wherein changing back to the previously selected additional driving program occurs when at least one of the following conditions is detected: a second speed threshold value is exceeded, a second acceleration value is exceeded, a second acceleration value is not reached, a second accelerator pedal angle threshold value is exceeded, a second accelerator pedal angle threshold value is not reached, a second lateral acceleration threshold value is exceeded, and a second lateral acceleration threshold value is not reached.

25. The motor vehicle according to claim 24, wherein changing back to the previously selected additional driving program occurs when the speed threshold value is exceeded and when at least one of the operating threshold values for the acceleration threshold value, the accelerator pedal angle threshold value and the lateral acceleration threshold value is exceeded.

26. The motor vehicle according to claim 24, wherein changing back to the previously selected additional driving program occurs when the speed threshold value is exceeded and when at least one of the operating threshold values for the acceleration threshold value, the accelerator pedal angle threshold value and the lateral acceleration threshold value is not reached.

27. The motor vehicle according to claim 24, wherein the additional operating parameter threshold value is predefined as a fixed value.

28. The motor vehicle according to claim 24, wherein the additional operating parameter threshold value is variable depending on at least one of an actual speed of the motor vehicle, a motor vehicle load, an inclination of the road and a driving strategy which forms a basis of the control operation.

29. The motor vehicle according to claim 24, wherein the second speed threshold value is higher than the first speed threshold value.

30. The motor vehicle according to claim 13 further comprising:
a display unit for displaying a selected driving program, wherein the display unit displays the originally selected additional driving program even if the gearbox control unit changes to the normal driving program.
